(19) United States
(12) Patent Application Publication
(10) Pub. No.: US 2026/0134105 A1
(43) Pub. Date: May 14, 2026

(54) SECURE AUTOMATED DEPLOYMENT OF CONTENT AND WORKLOADS FOR SOFTWARE DEFINED AUTOMATION IN A PROGRAMMABLE LOGIC CONTROLLER

(71) Applicant: ROCKWELL AUTOMATION TECHNOLOGIES, INC., MAYFIELD HEIGHTS, OH (US)

(72) Inventors: Brian P. Robinson, Morrisville, NC (US); Ryan L. Schnell, Chagrin Falls, OH (US); Diane E. Golden, West Allis, WI (US); Paul C. Whitten, Munson Township, OH (US)

(21) Appl. No.: 19/378,059

(22) Filed: Nov. 3, 2025

Related U.S. Application Data
(60) Provisional application No. 63/720,317, filed on Nov. 14, 2024.

(51) Int. Cl. G06F 21/57; H04L 9/30; H04L 9/32; H04L 9/40

(52) U.S. Cl. CPC G06F 21/572; H04L 9/30; H04L 9/321; H04L 63/20; G06F 2221/033

(57) ABSTRACT

Systems, industrial devices, and methods for controlling automated deployment of content and workloads within an industrial system. One system includes a processor. The processor may be configured to receive data to be deployed within the industrial system. The processor may be configured to generate a data packet based on the data. The processor may be configured to control secure deployment of the data packet to a set of industrial controllers included in the industrial system.

### CROSS-REFERENCES TO RELATED APPLICATIONS

This claims priority to U.S. Provisional Application No. 63/720,317, filed Nov. 14, 2024, the entire contents of which is incorporated herein by reference.

### BACKGROUND

This disclosure relates to industrial environments and platforms such as industrial automation systems or manufacturing environments. Industrial manufacturing environments may include computing and mechanical systems configured to implement an industrial process. In industrial automation environments, control systems are used to drive various operations along an industrial line. Control programs are developed by programmers in integrated design applications. The integrated design applications may include programming tools to design control schemes for the industrial manufacturing environments. The control programs are used by control systems like Programmable Logic Controllers (“PLCs”) to drive the industrial assets, devices, and sensors in an industrial process. The integrated design applications communicate with numerous systems within industrial manufacturing environments like PLCs and orchestration systems. Integrated design applications may also communicate with external systems. The numerous communication links may create security vulnerabilities in the integrated design applications.

The discussion above is merely provided for general background information and is not intended to be used as an aid in determining the scope of the claimed subject matter.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some examples, the technology disclosed herein provides a system of controlling automated deployment of content and workloads within an industrial system. The system may include a processor. The processor may be configured to receive deployment data to be deployed within the industrial system. The processor may be configured to generate a data packet based on the deployment data. The processor may be configured to control deployment of the data packet to a set of industrial controllers included in the industrial system.

In some examples, the technology disclosed herein provides a method of controlling automated deployment of content and workloads within an industrial system. The method may include receiving, with an electronic processor, deployment data to be deployed within the industrial system. The method may include generating, with the electronic processor, a data packet based on the deployment data. The method may include controlling, with the electronic processor, deployment of the data packet to a plurality of programmable logic controllers (PLCs) included in the industrial system.

In some examples, the technology disclosed herein provides a non-transitory, computer-readable medium storing instructions that, when executed by one or more electronic processors, perform a set of functions. The set of functions may include receiving deployment data to be deployed within an industrial system. The set of functions may include generating a data packet based on the deployment data. The set of functions may include controlling deployment of the data packet to a plurality of programmable logic controllers (PLCs) included in the industrial system.

The foregoing and other aspects and advantages of the present disclosure will appear from the following description. In the description, reference is made to the accompanying drawings which form a part hereof, and in which there is shown by way of illustrations one or more embodiments of the present disclosure. Such configurations do not necessarily represent the full scope of the present disclosure, however, and reference is made therefore to the claims and herein for interpreting the scope of the present disclosure.

### BRIEF DESCRIPTION OF DRAWINGS

The present disclosure will be better understood and features, aspects and advantages other than those set forth above will become apparent when consideration is given to the following detailed description thereof. Such detailed description makes reference to the following drawings.

FIG. 1 schematically illustrates a system for controlling automated deployment of content and workloads within an industrial system according to some configurations.

FIG. 2 schematically illustrates an example user device according to some configurations.

FIG. 3 schematically illustrates an example industrial controller of an industrial system according to some configurations.

FIG. 4 illustrates an example workflow for controlling automated deployment of content and workloads within an industrial system according to some configurations.

FIG. 5 illustrates a flowchart of a method for controlling automated deployment of content and workloads within an industrial system according to some configurations.

### DETAILED DESCRIPTION

As utilized herein, terms “component,” “system,” “controller,” “device,” “manager,” and variants thereof are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The disclosed technology is described with reference to the drawings, wherein like reference numerals are used to refer to like elements throughout. In the following description, for purposes of explanation, numerous specific details are set forth in order to provide a thorough understanding of the disclosed technology. It may be evident, however, that the disclosed technology may be practiced without these specific details. In other instances, well-known structures and devices are shown in block diagram form in order to facilitate describing the disclosed technology.

As noted herein, the technology disclosed herein relates generally to industrial systems, and, more particularly, to secure automated deployment of content and workloads (e.g., deployment data) for software defined automation (SDA) in industrial systems (e.g., in an industrial controller, such as, e.g., a programmable logic controller (PLC)). While the technology disclosed herein is described with respect to edge computing workload deployment, and, in some instances, edge computing workload deployment for industrial systems, the technology disclosed herein may be implemented or applied to other technologies, fields, use cases, industries, etc.

The technology disclosed herein is related to systems and methods for SDA, and more specifically, to SDA related to a PLC. For instance, the technology disclosed herein involves integrating Information Technology/Operational Technology (IT/OT) automation tools to deploy PLC content, applications and accompanying workloads (e.g., one or more sets of services that may collectively cooperate to perform a function of utility) for industrial control solutions in a secure manner to reduce the manual intervention traditionally involved. Integration with public key infrastructure (PKI), secure web services, or leveraging common open automation platforms may provide a secure approach of scaling deployment of PLC automation along with other infrastructure in a plant or industrial automation facility or environment.

Enterprise customers have workloads closely integrated with PLC applications and those customers may utilize open IT/OT automation to rapidly provision and deploy workload components across manufacturing facilities. Such automation may result in benefits in terms of time savings, fleet management, consistency, etc. Such automated provisioning and deployment have not been implemented with respect to PLCs. For instance, deployment of firmware and applications to PLCs have traditionally used proprietary tools and applications that do not integrate with IT/OT automation. As a result, deployment of PLC applications has been a manual, and time-consuming process.

Accordingly, traditional methods of deployment to PLCs involved implementation of multiple proprietary tools, such as, e.g., a proprietary tool for deploying workloads to PLCs, another proprietary tool for deploying configurations to PLCs, yet another proprietary tool for deploying firmware to PLCs, etc. For instance, deployment of workloads to PLCs may involve a first protocol, deployment of configurations to PLCs may involve another protocol, and deployment of firmware may involve yet another protocol or a different configuration of the same protocol. As one specific example, a program download to a PLC may occur over CIP using one object type, while a firmware download may use CIP with a different object, such as, e.g., an NVS object interaction.

The technology disclosed herein advantageously provides a technical solution that provides convergence of protocols such that a single automation tool may be implemented to deploy various types of content or workloads to a PLC (as opposed to utilizing multiple different proprietary tools). Accordingly, the technology disclosed herein advantageously allows for the integration of such automation platforms with respect to the provisioning and deployment of content or workloads for a PLC (e.g., deployment data), which traditionally has involved proprietary tools. Such integration may enable end-users to securely and flexibly deploy content (e.g., deployment data) to a PLC that is closely integrated with deployment and provisioning of other workloads across a plant or industrial facility or environment.

As described in greater detail herein, the technology disclosed herein may allow for such integration by: (1) using technology parity (e.g., Python) with an automation platform; and (2) leveraging a compatible public key infrastructure and management, which is to ensure content (e.g., deployment data) is deployed by only approved roles to devices provisioned for automated deployment (with keys unique to that customer or deployment). Content deployed to a PLC may be referred to herein as deployment data. Such deployment data may include, e.g., firmware, security credentials, configuration, patches, state, binaries, workloads, applications, and workflows, etc.

In some configurations, other secure interfaces not coupled to automation platforms (e.g., secure web services) along with enabling automation platform modules may flexibly and securely allow for deployment of, e.g., firmware, security credentials, configuration, patches, state, workloads, workflows, etc. (e.g., deployment data).

In some configurations, the technology disclosed herein may control access to resources by the content executed on the PLC based on, e.g., user accounts on the real-time operating system (RTOS), deployment keys on the PLC, etc. Physical user roles may be associated with a content deployment request by including a user authorization token signed by a security authority trusted by the device. Prior to executing the content deployment request, the device may verify that the request is authorized. In this way, the device can operate as a policy enforcement point in a zero-trust network architecture.

Additionally, deployment key(s) utilized by the PLC manufacturer's (e.g., Rockwell Automation's) infrastructure could be different from the key(s) utilized by the customer's IT/OT automation system. The PLC manufacturer's key(s) and customer key(s) may be tied to different user accounts with different access levels on the device. The customer may choose to further segment the role-based access control by provisioning different keys for different user accounts. For example, the customer may integrate third-party workloads via a more restrictive or isolated user account than enterprise workloads.

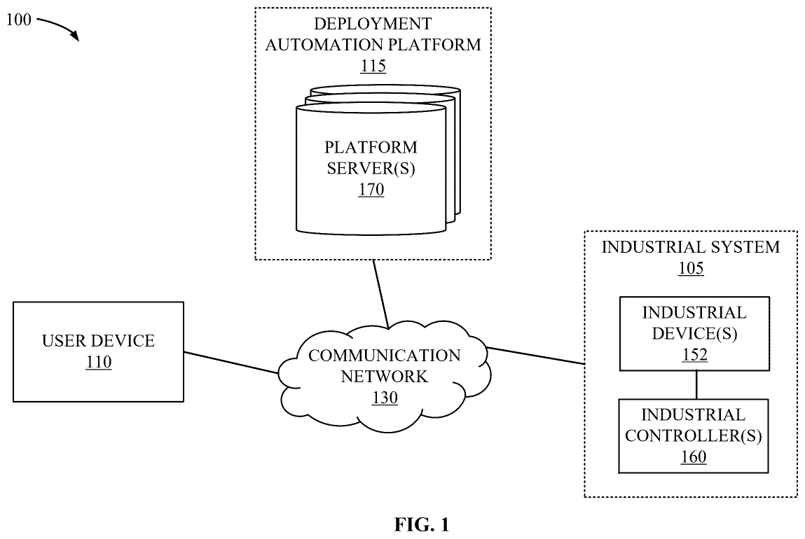

FIG. 1 schematically illustrates an example system 100 for secure automated deployment of content and workloads for software defined automation (SDA) in industrial systems according to some configurations. In the illustrated example, the system 100 may include an industrial system 105, a user device 110, and a deployment automation platform 115. In the example of FIG. 1, the industrial system 105 may include one or more industrial devices 152 (referred to herein collectively as “the industrial devices 152” and individually as “the industrial device 152”) and one or more industrial controllers 160 (referred to herein collectively as “the industrial controllers 160” and individually as “the industrial controller 160”), as described in greater detail herein. In some configurations, the system 100 includes fewer, additional, or different components in different configurations than illustrated in FIG. 1. As one example, the system 100 may include multiple industrial systems 105, multiple user devices 110, multiple deployment automation platforms 115, or a combination thereof. As another example, one or more components of the system 100 may be combined into a single device. Alternatively, or in addition, in some configurations, the user device 110, one or more components of the deployment automation platform 115, or a combination thereof may be included as part of the industrial system 105 (e.g., as a component of the industrial system 105).

The industrial system 105, the user device 110, and the deployment automation platform 115 may communicate over one or more wired or wireless communication networks 130. Portions of the communication networks 130 may be implemented using a wide area network, such as the Internet, a local area network, such as BLUETOOTH® or WI-FI®, and combinations or derivatives thereof. Alternatively, or in addition, in some configurations, components of the system 100 may communicate directly as compared to through the communication network 130. Also, in some configurations, the components of the system 100 may communicate through one or more intermediary devices not illustrated in FIG. 1.

The user device 110 may be a computing device, such as a desktop computer, a laptop computer, a tablet computer, a terminal, a smart telephone, a smart television, a smart wearable, or another suitable computing device that interfaces with a user. In some examples, the user device 110 may be included as a component of the industrial system 105, such as, e.g., a human-machine interface (HMI) of the industrial system 105. However, in some configurations, such as the configuration illustrated in FIG. 1, the user device 110 may be separate or remote from the industrial system 105.

In some configurations, the user device 110 may be an industrial personal computer (IPC). An IPC is a computing device that is specifically designed or otherwise configurated for user in industrial environments (e.g., harsh or rugged environments relative to a traditional office setting). For instance, IPCs may be specifically designed for continuous operation (e.g., 24 hours a day and 7 days a week), extreme or severe environmental conditions (e.g., temperatures, vibrations, electric noise, dust, moisture, etc.), etc. Such IPCs may be configured to facilitate control or operations related to an industrial process of the industrial system 105. For example, an IPC may perform operations or functionality related to factory automation, machine vision systems, robotics control, data logging or monitoring, etc.

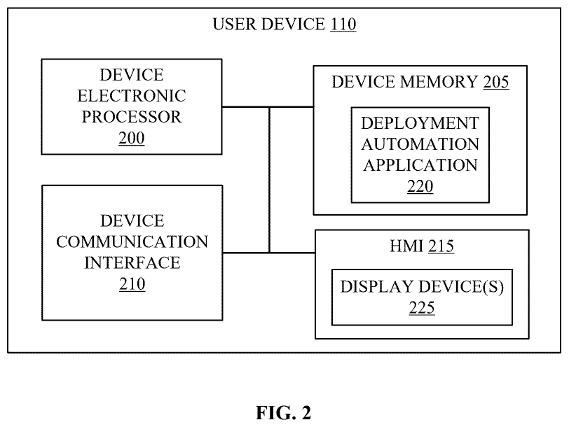

As illustrated in FIG. 2, the user device 110 may include a device electronic processor 200, a device memory 205, a device communication interface 210, and a human-machine interface (“HMI”) 215. The device electronic processor 200, the device memory 205, the device communication interface 210, and the HMI 215 may communicate wirelessly, over one or more communication lines or buses, or a combination thereof. The user device 110 may include additional components than those illustrated in FIG. 2 in various configurations. The user device 110 may also perform additional functionality other than the functionality described herein. Also, the functionality (or a portion thereof) described herein as being performed by the user device 110 may be distributed among multiple devices (e.g., as part of a cloud service or cloud-computing environment), combined with another component of the system 100, or a combination thereof.

The device communication interface 210 may include a transceiver that communicates with the industrial system 105 (or component(s) thereof), the deployment automation platform 115 (or component(s) thereof), another component of the system 100, or a combination thereof over the communication network 130 and, optionally, one or more other communication networks or connections. Accordingly, in some configurations, the device communication interface 210 enables the user device 110 to communicate with the industrial system 105 (or component(s) thereof), the deployment automation platform 115 (or component(s) thereof), another component of the system 100, or a combination thereof over one or more wired or wireless connections. The device electronic processor 200 may include a microprocessor, an application-specific integrated circuit (ASIC), or another suitable electronic device for processing data, and the device memory 205 includes a non-transitory, computer-readable storage medium. The device electronic processor 200 is configured to retrieve instructions and data from the device memory 205 and execute the instructions.

As one example, as illustrated in FIG. 2, the device memory 205 may include a deployment automation application 220. Although FIG. 2 illustrates the deployment automation application 220 as being stored in the device memory 205, in some configurations, the deployment automation application 220 may be stored external to the device memory 205, such as in one or more remote devices.

The deployment automation application 220 may be a software application executable by the device electronic processor 200 in the example illustrated and as specifically discussed below, although a similarly purposed module may be implemented in other ways in other examples. In some configurations, the deployment automation application 220 enables interaction between the deployment automation platform 115 (or components thereof) and a user of the user device 110.

For example, in some configurations, the device electronic processor 200 of the user device 110 may execute the deployment automation application 220 to facilitate generation (or creation) of content to be deployed or provisioned to managed nodes within the industrial system 105 (e.g., the industrial controller(s) 160, the industrial device(s) 152, etc.). As noted herein, content to be deployed or provisioned to managed node(s) of the industrial system 105 may be referred to herein as deployment data. For instance, device electronic processor 200 may execute the deployment automation application 220 to generate and provide a user interface or a graphical user interface (GUI) that a user of the user device 110 may interact with in order to generate (or create) content to be deployed or provided to the managed node(s) of the industrial system 105.

A managed node may be (or otherwise include) an embedded device of the industrial system 105. For example, a managed node may include the industrial controller 160, the industrial device(s) 152, or a combination thereof. As one specific example, a managed node may include a PLC. In some examples, the managed node(s) may include embedded device(s) running, e.g., a real-time operating system of the industrial system 105. In some instances, the deployment data (e.g., content to be deployed or provisioned within the industrial system 105) may include, e.g., firmware, a security credential, a configuration, a patch, a state, binaries, a workload, a workflow, etc. In some specific examples, the deployment data may include database server workloads, web server workloads, etc. A workload may relate to (or otherwise include) a set of tasks or operations to be performed (or otherwise executed) by a managed node of the industrial system 105 (e.g., the industrial controller(s) 160, the industrial device(s) 152, etc.). In some examples, the deployment automation application 220 may facilitate generation (or creation) of an automation playbook (e.g., as the deployment data). An automation playbook may include one or more configuration files describing the content (e.g., the workloads, etc.) to be deployed to managed nodes of the industrial system 105. As such, in some instances, an automation playbook may be the deployment data.

As noted herein, in some configurations, the user device 110 may include the HMI 215 for interacting with a user. The HMI 215 may include one or more input devices, one or more output devices, or a combination thereof. Accordingly, in some configurations, the HMI 215 allows a user to interact with (e.g., provide input to and receive output from) the user device 110. For example, the HMI 215 may include a keyboard, a cursor-control device (e.g., a mouse), a touch screen, a scroll ball, a mechanical button, a display device (e.g., a liquid crystal display (“LCD”)), a printer, a speaker, a microphone, another type of input device, another type of output device, or a combination thereof. As one example, as illustrated in FIG. 2, the HMI 215 may include one or more display devices 225. In some examples, the display device(s) 225 may be included in the same housing as the user device 110 (e.g., as a display screen of the user device 110). Alternatively, or in addition, in some instances, the display device(s) 225 may communicate with the user device 110 over one or more wired or wireless connections. For example, in some configurations, the display device(s) 225 is a touchscreen included in a laptop computer or a tablet computer (e.g., the user device 110). In other examples, the display device(s) 225 is a monitor, a television, or a projector coupled to a terminal, a desktop computer, or the like via one or more cables.

Returning to FIG. 1, the system 100 may also include the deployment automation platform 115. As illustrated in FIG. 1, the deployment automation platform 115 may include one or more platform servers 170 (referred to herein collectively as “the platform servers 170” and individually as “the platform server 170”). Although not illustrated in FIG. 1, the platform server(s) 170 may include similar components as the user device 110, such as an electronic processor (for example, a microprocessor, an ASIC, or another suitable electronic device), a memory (for example, a non-transitory, computer-readable storage medium), a communication interface, such as a transceiver, for communicating over the communication network 130 and, optionally, one or more additional communication networks or connections, and one or more HMIs. For example, to communicate with the user device 110, the platform server(s) 170 may store a browser application or a dedicated software application executable by an electronic processor. The platform server(s) 170 may host or otherwise provide at least one deployment automation service or platform (e.g., a deployment automation tool that may orchestrate and deploy content to managed node(s) of the industrial system 105). In some configurations, the functionality described herein as being performed by the user device 110 may be locally performed by the platform server(s) 170. For example, in some configurations, the platform server(s) 170 may store the deployment automation application 220. Alternatively, in some configurations, the functionality described herein as being performed by the platform server(s) 170 may be locally performed by the user device 110 (e.g., via execution of the deployment automation application 220.

As described herein, in some instances, the user device 110 (e.g., via execution of the deployment automation application 220 by the device electronic processor 200) may interact with the deployment automation platform 115 (e.g., the platform server(s) 170 thereof). Accordingly, in some configurations, the deployment automation platform 115 may facilitate the generation (or creation) of deployment data (or content) to be deployed (or provisioned) to managed nodes of the industrial system 105. For example, a user may interact with the deployment automation application 220 to generate an automation playbook (e.g., a set of configuration files) for deployment (or provisioning) with respect to the industrial system 105 (or managed node(s) therein). Alternatively, or in addition, in some configurations, the deployment automation platform 115 may facilitate the orchestration and deployment (or provisioning) of deployment data (or content) with respect to the industrial system 105 (or managed node(s) therein). For example, the deployment automation platform 115 may orchestrate and deploy (or provision) an automation playbook (e.g., a set of configuration files) with respect to the industrial system 105 (or managed node(s) therein). As such, in some instances, the deployment automation platform 115 (or the platform server(s) 170 thereof) may interact with the industrial system 105 (e.g., the industrial device(s) 152, the industrial controller(s) 160, etc.), such as, e.g., via the communication network(s) 130.

The industrial system 105 may be a manufacturing system, such as, e.g., an industrial automation system or the like. The industrial system 105 may be associated with (or located at) a facility or site. In some configurations, a facility or site may include multiple industrial systems 105 (e.g., a first industrial system, a second industrial system, a third industrial system, etc.). Accordingly, in some configurations, the industrial system 105 may be implemented at a facility. Alternatively, or in addition, in some configurations, the system 100 may include a first industrial system located at a first facility and a second industrial system located as a second facility different from the first facility. The industrial system 105 may be configured to perform one or more industrial processes, manufacturing processes, production processes, automation processes, or the like. In some configurations, the industrial system 105 may perform a production method that produces goods or products. As one example, the industrial system 105 may perform a vehicle manufacturing process to assemble or produce a vehicle (or various components thereof). As another example, the industrial system 105 may perform a food manufacturing process for making a food product. As yet another example, the industrial system 105 may perform a pharmaceutical manufacturing process for producing pharmaceuticals.

As such, in some configurations, the industrial system 105 can be used to execute or automate manufacturing processes in industries such as, e.g., aerospace, automotive, cement, chemical processing, food and beverage, household and personal care, life sciences, marine operations, metals processing, mining operations, oil and gas, power generation, print and publishing, pulp and paper, semiconductors, warehouse and fulfillment, and wastewater treatment, among others.

In the illustrated example of FIG. 1, the industrial system 105 may include one or more industrial devices 152. The industrial device(s) 152 may be a physical piece of equipment included in the industrial system 105. For example, an industrial device 152 may include a pump, a press, a conveyor, a valve, a switch, a motor, a motion device, a sensor, a server, a database, an HMI, another piece of equipment that may be used in connection with an associated industrial process or application of the industrial system 105, or the like.

As illustrated in FIG. 1, in some configurations, the industrial system 105 may include one or more industrial controllers 160. The industrial controller 160 may be a PLC. In some specific examples, the industrial controller 160 may be an SDA PLC (e.g., a PLC configured to implement or otherwise facilitate functions or functionality related to SDA). As described herein, the industrial controller 160 may facilitate (or otherwise control) performance of an industrial process (or portion(s) thereof) with respect to the industrial system 105.

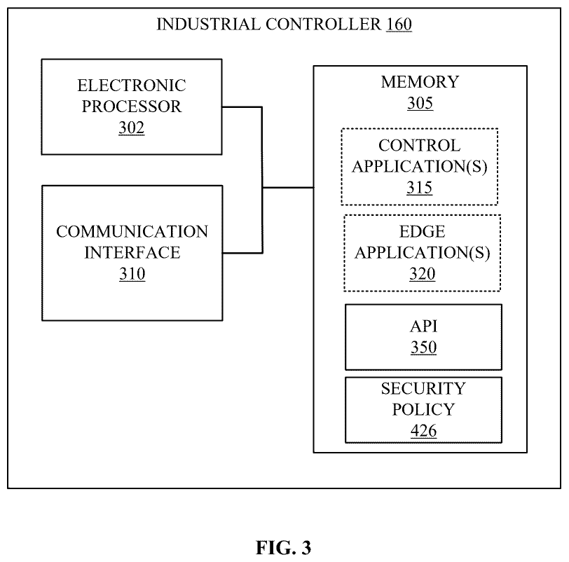

FIG. 3 illustrates an example industrial controller 160 of the industrial system 105. As illustrated in FIG. 3, the industrial controller 160 may include an electronic processor 302, a memory 305, and a communication interface 310. The electronic processor 302, the memory 305, and the communication interface 310 may communicate wirelessly, over one or more communication lines or buses, or a combination thereof. The industrial controller 160 may include additional, different, or fewer components than those illustrated in FIG. 3 in various configurations. The industrial controller 160 may also perform additional or different functionality other than the functionality described herein.

The communication interface 310 may include a transceiver that communicates with the industrial system 105 (e.g., the industrial device(s) 152 of the industrial system 105, another component or device of the industrial system 105, etc.), the user device 110, the deployment automation platform 115 (or the platform server(s) 170 thereof), or a combination thereof over the communication network 130 and, optionally, one or more other communication networks or connections. In some configurations, the communication interface 310 enables the industrial controller 160 to communicate with the industrial system 105 (e.g., the industrial device(s) 152 of the industrial system 105, another industrial controller of the industrial system 105, etc.), the user device 110, the deployment automation platform 115 (or the platform server(s) 170 thereof), or a combination thereof over one or more wired or wireless connections. The electronic processor 302 may include a microprocessor, an ASIC, or another suitable electronic device for processing data, and the memory 305 includes a non-transitory, computer-readable storage medium. The electronic processor 302 is configured to retrieve instructions and data from the memory 305 and execute the instructions.

For example, as illustrated in FIG. 3, the memory 305 may include one or more applications. In some configurations, as illustrated in FIG. 3, the memory 305 may include a control application 315. The control application 315 may be a control program of the industrial controller 160. In some cases, the control application 315 may control (or otherwise facilitate) a real-time (or near real-time) operation of the industrial system 105 (or industrial process(es) performed thereby). For instance, the control application 315 may include one or more executable instructions that implement (or otherwise) control implementation or execution of an industrial process (or portion(s) thereof) of the industrial system 105. In some instances, the control application 315 may be in a programming language specific for industrial controllers or PLCs (e.g., a PLC programming language), such as, e.g., ladder logic, function block diagram, structured text, sequential function chart, etc.

In some examples, the control application 315 may control performance of various functions (or logic) by one or more of the industrial devices 152 (e.g., drive industrial assets, devices, and sensors in an industrial process of the industrial system 105). In some instances, the control application 315 may relate to, e.g., a monitoring process, an automation process, a data acquisition process, a sequence management process, an error detection process, a fault detection process, etc. For example, the control application 315 may include one or more operations related to the industrial device(s) 152, such as, e.g., one or more switching operations, load isolation operations, signal routing operations, torque control operations, acceleration control operations, deceleration control operations, or the like. In some instances, execution of the control application 315 (or portion(s) thereof) may involve (or otherwise include) one or more logic functions. For example, the electronic processor 302 may perform (or otherwise execute) a logic function to execute the control application 315 (or portion(s) thereof). As one example, the control application 315 may include a routine involving a sequence of logic to be executed as a block (e.g., a sequence of one or more logic functions). Following this example, to execute the control application 315, the electronic processor 302 may execute the routine by executing the sequence of logic of that routine.

As illustrated in FIG. 3, the control application 315 is included in the memory 305 of the industrial controller 160. As such, in some instances, the control application 315 may be local to the industrial controller 160 (e.g., a PLC). However, in some configurations, the control application 315 (or portion(s) thereof), may be included in a separate device accessible by the industrial controller 160 (included in the industrial controller 160 or external to the industrial controller 160).

In the illustrated example of FIG. 3, in some configurations, the memory 305 may include one or more edge applications 320 (referred to herein collectively as “the edge applications 320” and individually as “the edge application 320”). As such, in some instances, the edge application(s) 320 may be local to the industrial controller 160 (e.g., a PLC). As described herein, the edge application(s) 320 may include (or otherwise involve) computing workloads of an end-user (also referred to herein as “edge workloads”). For instance, the edge application(s) 320 may include workloads related to (or otherwise involving), e.g., motion, vision, data acquisition, HMI, historian, analytics, artificial intelligence (AI) inference and machine learning, predictive modeling, autonomous mobile robot (AMR) applications, etc. As such, in some instances, the edge application(s) 320 may be an analytics application, a historian application, a data acquisition application, a motion application, an HMI application, etc. As described herein, in traditional implementations, such edge applications typically reside on edge or supplemental computing devices, such as, e.g., the user device 110, an IPC, another component or device of the industrial system 105, etc. In some instances, the edge application(s) 320 may be in a general-purpose programming language (e.g., a programming language that is not specific to industrial controllers or PLCs), such as, e.g., Python, C, C++, Java, etc. As such, in some instances, the control application 315 may be in a first programming language while the edge application(s) 320 may be in a second programming language different than the first programming language.

In some configurations, the industrial controller 160 may be a managed node of the industrial system 105, as described herein. As such, in some instances, the control application(s) 315, the edge application(s) 320, or a combination thereof may be related to (or otherwise associated with) content deployed (or provisioned) via the deployment automation platform 115 (or the platform server(s) 170 thereof), as described herein. For instance, the control application(s) 315, the edge application(s) 320, or a combination thereof may be (or be included in) the deployment data. As one example, the control application(s) 315, the edge application(s) 320, or a combination thereof may be (or included in) an automation playbook that the deployment automation platform 115 (or the platform server(s) 170 thereof) orchestrated and deployed to the industrial controller 160 (e.g., as a managed node of the industrial system 105).

As illustrated in FIG. 3, in some instances, the industrial controller 160 may include an application programming interface (API) 350. In some examples, the API 350 may be a representational state transfer (REST) API. Accordingly, in some configurations, the API 350 may facilitate communication between the industrial controller 160 and one or more external or remote devices. For instance, in some examples, the industrial controller 160 may interact with (or otherwise communicate) via the API 350 with the user device 110, the deployment automation platform 115 (or the platform server(s) 170 thereof), or a combination thereof. As one specific example, in some configurations, the deployment automation platform 115 (or the platform server(s) 170 thereof) may orchestrate and deploy the deployment data to the industrial controller 160 via the API 350, as described herein.

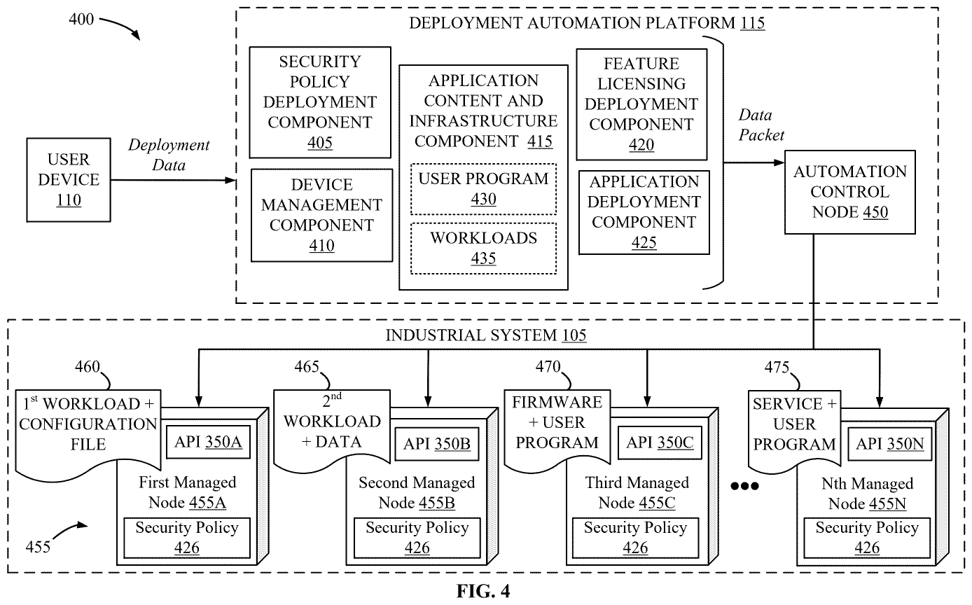

FIG. 4 illustrates an example workflow 400 according to some configurations. For instance, FIG. 4 illustrates communication between various components (or environments) of the system 100, such as, e.g., between the user device 110, the deployment automation platform 115, and the industrial system 105, in accordance with some configurations.

As illustrated in the example of FIG. 4, the user device 110 may interact with the deployment automation platform 115 (e.g., the platform server(s) 170 thereof). As described herein, the interaction between the user device 110 and the deployment automation platform 115 may include generation (or creation) of deployment data (or content) for deployment (or provisioning) to the industrial system 105, such as, e.g., an automation playbook or a set of configuration files.

In some configurations, the deployment automation platform 115 may implement various processes or functions with respect to the deployment data received from the user device 110. For instance, as illustrated in FIG. 4, the deployment automation platform 115 may include a security policy deployment component 405, a device management component 410, an application content and infrastructure component 415, a feature licensing deployment component 420, and an application deployment component 425. In some configurations, the security policy deployment component 405, the device management component 410, the application content and infrastructure component 415, the feature licensing deployment component 420, the application deployment component 425, or a combination thereof may be implemented (or otherwise performed) via one or more of the platform server(s) 170 (e.g., electronic processor(s) thereof).

The security policy deployment component 405 may control (or otherwise facilitate) deployment of one or more security policies 426 to one or more managed nodes 455. In some configurations, the security policy deployment component 405 may automate (or automatically) deploy the security policies 426 to the managed node(s) 455. In some instances, each security policy 426 may be specific to the corresponding managed node 455. Alternatively, in some instances, two or more of the security policies 426 may be the same (e.g., two or more of the managed nodes 455 may implement or otherwise enforce the same security policy 426).

In some configurations, the security policy deployment component 405 may set (or otherwise establish) the security policies 426. The security policies 426 may include, e.g., setting firewall rules, enabling or disabling physical ports (i.e., USB ports, NFC, Bluetooth, Ethernet, etc.), configuration setting for syslog (e.g., verbosity levels, remote syslog collector location, secure syslog setup, etc.), deploying security certificates, forcing various communications protocols to utilize secure versions (and blocking insecure versions), provisioning a central security authority, or automated local user account settings, set user password complexity policy rules (e.g., types of allowed and required characters, length, prevent password reuse, minimum or maximum password change frequency, etc.), force user password changes, etc.

In some examples, the deployment automation platform 115 may send a request (e.g., a request to which authorization has yet to be determined) to the managed node(s) 455 such that the managed node(s) 455 may reject or accept requests based on a corresponding security policy 426. For example, when a request is not authorized, the managed node 455 may reject the request. Alternatively, when a request is authorized, the managed node 455 may accept (or grant) the request. While the security policies 426 are illustrated as being implemented at each respective managed node 455, in some configurations, the security policies 426 may be implemented within the deployment automation platform 115, such as, e.g., by the security policy deployment component 405. As such, in some instances, the deployment automation platform 115 may not be trusted by the managed node(s) 455. In such instances, the managed node(s) 455 may treat API request(s) as untrusted and validate request(s) on a request-by-request basis.

For instance, the managed node(s) 455 may utilize (or otherwise implement) the security policies 426 for one or more security-related processes or functions (e.g., security enforcement), such as, e.g., as part of API security. As one example, the security policies 426 may involve (or otherwise relate to) user authorization (or authentication) with respect to the deployment data. For instance, the managed node(s) 455 may utilize the security policy 426 to confirm whether the user providing the deployment data has authority to deploy (or provision) the deployment data with respect to the industrial system 105. As one specific example, when the deployment data relates to changing a configuration of a managed node, the managed node(s) 455 may utilize the security policy 426 to confirm whether the user providing that deployment data has the authorization to change the configuration of the managed node(s) 455. As another specific example, when the deployment data relates to a firmware deployment (e.g., deploying firmware to the managed node(s) 455), the managed node(s) 455 may utilize the security policy 426 to determine whether the user providing the deployment data is authorized to deploy firmware to the managed node(s) 455. As yet another specific example, when the deployment data relates to a user program deployment (e.g., deploying a user program to the managed node(s)), the managed node(s0 455 may utilize the security policy 426 to determine whether the user providing the deployment data is authorized to deploy user programs to the managed node(s) 455, deploy that specific user program to the managed node(s) 455, etc.

As such, in some instances, security enforcement (e.g., the security policy 426) may be based on an identity or a role of a user. For example, the managed node(s) 455 may utilize the security policy 426 to implement various user-based or role-based permissions with respect to deployment of the deployment data. In some instances, user data or information may be included in the development data such that the deployment automation platform 115 may determine an identity of the user providing the development data. Such user data or information may include, e.g., a username, a personal identification number, an account number, a name, an email address, another type of unique identifying data or information, etc. Additionally, in some instances, the managed node(s) 455 may access deployment permissions or data (e.g., the security policies 426). The deployment permission or data may define permissions with respect to deployment automation for the industrial system 105. The deployment permission or data may be stored locally at the managed node(s) 455 (e.g., as the security policies 426). Alternatively, or in addition, the deployment permission or data may be accessible to the managed node(s) 455 from an external source or remote device, such as, e.g., the user device 110.

As such, in some configurations, the technology disclosed herein may control access to resources by content deployed to and executed on the industrial controller(s) 160. In some configurations, security enforcement may control access based on, e.g., user accounts on a real-time operating system (RTOS) of the industrial system 105 (or component(s) thereof), one or more deployment keys related to the industrial controller(s) 160, etc.

As noted, in some configurations, security enforcement (or component(s) thereof) outside of the managed node(s) 455 may provide authorization information (e.g., the security policies 426) which the managed node(s) 455 may use to control access. Such configurations may involve a “central authority” (e.g., the security policy 426 may configured a central authority). In some examples, the central authority may be associated with a single sign-on system utilizing technology such as, e.g., OpenID Connect and OAuth 2.0.

Accordingly, in some configurations, the managed node(s) 455 may include an internal security component (e.g., the security policy 426) that may control access based on deployment permission data, such as, e.g., user accounts, physical user roles, deployment keys, etc. (e.g., the security policies 426). For example, in some examples, the managed node(s) 455 (via an internal security component, such as, e.g., the security policy 426) may control access based on physical user roles. Physical user roles may be associated with a content deployment request (e.g., a user providing content or workloads for deployment to the managed node(s) 455 of the industrial system 105). For example, a content deployment request may include development data (as described herein) and a user authorization token. The user authorization token may be signed by a trusted security authority (e.g., a local authority inside the managed node(s) 455 or a remote authority outside of the managed node(s) 455). In some instances, prior to implementing or executing the content deployment request (e.g., at the managed node(s) 455), the internal security component of the managed node(s) 455 (e.g., via the security policies 426) may verify (or otherwise determine) whether the content deployment request is authorized based on the user authorization token (e.g., a validity of the user authorization token). When the content deployment request is authorized (e.g., the user authorization token is valid), the content deployment request may be executed (e.g., content related to the content deployment request may be deployed or otherwise implemented), as described herein. When the content deployment request is not authorized (e.g., the user authorization token is not valid or invalid), the content deployment request may not be executed (e.g., content related to the content deployment request may be prevented from being deployed or otherwise implemented), as described herein. In this way, the internal security component of the managed node(s) 455 (e.g., the security policy 426) may operate as a policy enforcement point in a zero-trust network architecture.

Alternatively, or in addition, in some configurations, the internal security component of the managed node(s) 455 (e.g., the security policy 426) may control access based on deployment keys (e.g., manufacturer keys or customer keys). For example, in some cases, a manufacturer of the industrial controller(s) 160 may include (or otherwise embed) a manufacturer key for each industrial controller 160. The manufacturer keys may be different from customer key(s) utilized by an IT/OT automation system of a customer (or end-user) (e.g., the deployment automation platform 115). The manufacturer key(s) and the customer key(s) may be tied to different user accounts with different access levels on the industrial controller(s) 160. In some instances, a customer may choose to further segment the role-based access control by provisioning different keys for different user accounts. As one example, a customer may integrate third-party workloads via a more restrictive or isolated user account than enterprise workloads.

Accordingly, in some configurations, the internal security component of the managed node(s) 455 (e.g., the security policy 426) may determine an authorization status of the deployment data based on, e.g., the deployment permission data (e.g., user accounts, physical user role, deployment keys, etc.). In some cases, the authorization status may be an authorized status, such as, e.g., when a user authorization token is valid, when the deployment data complies with an access level of a user account or a customer key associated with the deployment data, etc. However, in some cases, the authorization status may be a not authorized status, such as, e.g., when a user authorization token is invalid, when the deployment data fails to comply with an access level of a user account or a customer key associated with the deployment data, etc.

The device management component 410 may implement (or otherwise facilitate) one or more device management related processes or functions. In some configurations, such device management related processes or functions may involve fleet management or configuration thereof. For example, the device management component 410 may determine or configure what firmware revisions, what workloads, what user programs, etc. to deploy based on the deployment data.

The application content and infrastructure component 415 may implement (or otherwise facilitate) one or more processes or functions related to application content and infrastructure (e.g., with respect to the deployment data). In some examples, the application content and infrastructure component 415 may include an inventory or catalog of various content or workloads. For instance, as illustrated in FIG. 4, the application content and infrastructure component 415 may include (or otherwise indicate) one or more user programs 430, one or more workloads 435, etc.

The feature licensing deployment component 420 may implement (or otherwise facilitate) one or more processes or functions related to a licensed feature. For instance, in some cases, the deployment automation platform 115 may attempt to deploy content (e.g., the deployment data) that may be associated with (or otherwise involve) deployment of a feature (or function) that is subject to a license (e.g., in order to be run). In such instances, the managed node(s) 455 may enforce feature licensing with respect to such licensed content (e.g., confirm or otherwise determine whether a license related to that feature is valid or invalid). In some cases, the managed node(s) 455 may prevent or rejection deployment of the licensed feature (or content) when the license related to that feature is invalid or insufficient (e.g., missing, defective, expired, etc.).

Accordingly, in some instances, the deployment automation platform 115 (e.g., via the feature licensing deployment component 420) may automate the deployment of feature licenses to the managed node(s) 455. In some configurations, the deployment automation platform 155 (e.g., the feature licensing deployment component 420) may check or confirm what licenses a managed node 455 has, and content requiring additional feature licenses is attempting to be deployed, the deployment automation platform 155 (e.g., the feature licensing deployment component 420) may automate a request for and delivery process of those licenses.

As one specific example, when a customer has purchased 10 licenses for a particular feature, and the customer has only activated/deployed 5 licenses, the deployment automation platform 115 (e.g., the feature licensing deployment component 420) may 1) verify which feature licenses are required for a particular application content payload; 2) confirm the managed node(s) 455 being deployed to is missing a license; 3) ask a higher level licensing system to assign an available license to the managed node(s) 455; 4) deliver the license to the managed node(s) 455; 5) deliver the payload that requires that particular feature license; etc.

The application deployment component 425 may implement (or otherwise facilitate) one or more processes or functions related to deployment of the deployment data. In some instances, the application deployment component 425 may generate a data packet based on the deployment data, one or more results of performing the processes or functions of the deployment automation platform 115 on the deployment data (e.g., the security policy deployment component 405, the device management component 410, the application content and infrastructure component 415, the feature licensing deployment component 420, or a combination thereof), etc. In some instances, the application deployment component 425 may generate an executable file or an application based on the deployment data (e.g., as a data packet). As one specific example, when the deployment data is a firmware revision, the application deployment component 425 may generate an executable file (e.g., a data packet) that, when executed, may implement the firmware revision (e.g., an executable firmware revision file).

As also illustrated in FIG. 4, the deployment automation platform 115 may include an automation control node 450. The automation control node 450 may control orchestration and deployment of the deployment data (or an executable file or application based thereon). For example, as illustrated in FIG. 4, the automation control node 450 may receive a data packet (e.g., the deployment data, an executable file, an application, etc.) from, e.g., the application deployment component 425. Responsive to receipt of the data packet, the automation control node 450 may control the orchestration and deployment of the data packet with respect to the industrial system 105.

As illustrated in FIG. 4, the industrial system 105 includes a first managed node 455A, a second managed node 455B, a third managed node 455C, and a Nth managed node 455N. As further illustrated in FIG. 4, in some configurations, each managed node may be associated with (or otherwise include) a corresponding application programming interface (API) (e.g., the API 350 of FIG. 3). For instance, the first managed node 455A may implement a first API 350A, the second managed node 455B may implement a second API 350B, the third managed node 455C may implement a third API 350C, and the Nth managed node 455N may implement a Nth API 350N. As noted herein, in some instances, the API(s) 350 may be REST API(s). In the example of FIG. 4, the automation control node 450 may orchestrate and deploy data packets (e.g., the deployment data) to the managed node(s) using the corresponding API(s) 350.

As one specific example, the automation control node 450 may orchestrate and deploy a first data packet 460 (e.g., first deployment data or a first application) to the first managed node 455A via the first API 350A. As illustrated in FIG. 4, following this example, the first data packet 460 may include or otherwise relate to a first workload and a configuration file.

As another specific example, the automation control node 450 may orchestrate and deploy a second data packet 465 (e.g., second deployment data or a second application) to the second managed node 455B via the second API 350B. As illustrated in FIG. 4, following this example, the second data packet 465 may include or otherwise relate to a second workload and data.

As yet another specific example, the automation control node 450 may orchestrate and deploy a third data packet 470 (e.g., third deployment data or a third application) to the third managed node 455C via the third API 350C. As illustrated in FIG. 4, following this example, the third data packet 470 may include or otherwise relate to firmware and a user program (e.g., the user program 430).

As still another specific example, the automation control node 450 may orchestrate and deploy a Nth data packet 475 (e.g., Nth deployment data or a Nth application) to the Nth managed node 455N via the Nth API 350N. As illustrated in FIG. 4, following this example, the Nth data packet 475 may include or otherwise relate to a service and a user program (e.g., the user program 430).

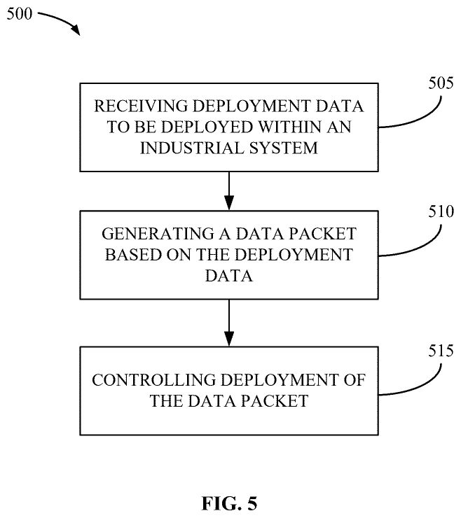

FIG. 5 is a flowchart illustrating a method 500 controlling automated deployment of content and workloads within an industrial system according to some configurations. The method 500 is described as being performed by the platform server(s) 170 (e.g., one or more electronic processors of the platform server(s) 170). However, as noted herein, the functionality described with respect to the method 500 may be performed by other devices, such as the industrial device(s) 152, the industrial controller(s) 160, the user device 110, another component of the industrial system 105, or a combination thereof, distributed among a plurality of devices, such as a plurality of servers included in a cloud service, or a combination thereof. As described below, a particular implementation can omit some or all illustrated features/steps, may be implemented in some embodiments in a different order, and may not involve some illustrated features to implement all embodiments.

As illustrated in FIG. 4, the method 500 may include receiving deployment data to be deployed within the industrial system 105 (at block 505). As described in greater detail herein, the deployment automation platform 115 (e.g., the platform server(s) 170) may receive deployment data from the user device 110. For instance, a user of the user device 110 may interact with the deployment automation application 220 by providing deployment data (e.g., via a content deployment request). As described herein, the deployment data may include data or information related to content and workloads to be deployed to managed node(s) of the industrial system 105 (e.g., the industrial controller(s) 160). For instance, the deployment data may include, e.g., firmware, a security credential, a configuration file, a patch, a state, a binary, a user program, a workflow, etc.

The platform server(s) 170 (or the electronic processor(s) thereof) may generate a data packet based on the deployment data (at block 510). As described in greater detail herein, in some configurations, the data packet may be based on the deployment data, one or more results of performing the processes or functions of the deployment automation platform 115 on the deployment data (e.g., the security policy deployment component 405, the device management component 410, the application content and infrastructure component 415, the feature licensing deployment component 420, or a combination thereof), etc. In some instances, the data packet may include (or otherwise be associated with) an executable file or an application based on the deployment data. For example, the data packet may be firmware, a user program, data, a configuration file, a service, a workload, etc.

The platform server(s) 170 (e.g., the electronic processor(s) thereof) may control deployment of the data packet to the industrial controller(s) 160 included in the industrial system 105 (at block 515). As described in greater detail herein, in some configurations, the platform server(s) 170 (e.g., the automation control node 450 of FIG. 4) may orchestrate or deploy the data packet to the industrial controller(s) 160 (e.g., the managed node(s) 455 of FIG. 4) using the API(s) 350. In some examples, the API(s) 350 may be REST APIs. As described herein, in some configurations, the API(s) 350 may be local to the industrial controller(s) 160.

In some configurations, upon receipt of the data packet at the industrial controller(s) 160 (e.g., the managed node(s) 455 of FIG. 4), the industrial controller(s) 160 (e.g., the managed node(s) 455) may execute (or otherwise perform) one or more operations related to security enforcement, as described in greater detail herein. For instance, in some configurations, the industrial controller(s) 160 may enforce the security policy 426, as described in greater detail herein.

For instance, in some configurations, the electronic processor 300 of the industrial controller 160 may determine an authorization status related to the deployment data (e.g., as received at block 505). For instance, in some configurations, the electronic processor 300 may determine the authorization status of the deployment data (e.g., the data packet being deployed by the automation control node 450) based on deployment permission data (e.g., the security policy 426), as described in greater detail herein.

For example, in some configurations, the electronic processor 302 of the industrial controller 160 may control deployment of the data packet based on an authorization status related to the deployment data (or a content deployment request related thereto) (e.g., the data packet). As described herein, the electronic processor 302 may determine the authorization status based on deployment permission data, such as, e.g., user authentication tokens, deployment keys, etc. (e.g., the security policy 426). When the authorization status indicates that deployment of the data packet (e.g., the deployment data thereof) is not authorized, the electronic processor 302 may prevent (or otherwise block) deployment of the data packet (e.g., the deployment data thereof). For example, the electronic processor 302 may not install the data packet at the industrial controller 160 responsive to determining that the deployment of the data packet (or a content deployment request related thereto) is unauthorized (e.g., not authorized). When the authorization status indicates that deployment of the data packet (e.g., the deployment data thereof) is authorized, the electronic processor 302 may deploy (or otherwise facilitate deployment) of the data packet. For instance, the electronic processor 302 may install the data packet at the industrial controller 160 responsive to determining that the deployment of the data packet (or a content deployment request related thereto) is authorized.

As one specific example, in some configurations, the electronic processor 302 may determine the authorization status of the deployment data (e.g., the data packet) using a user authorization token, as described herein. When the authorization status of the deployment data (e.g., the data packet) indicates that the user authorization token is invalid, the electronic processor 302 may prevent (or otherwise block) deployment (or installation) of the data packet (e.g., the deployment data thereof) at the industrial controller 160. When the authorization status of the deployment data (e.g., the data packet) indicates that the user authorization token is valid, the electronic processor 302 may deploy (or install) of the data packet (e.g., the deployment data thereof) at the industrial controller 160.

What has been described above includes examples of the disclosed technology. It is, of course, not possible to describe every conceivable combination of components or methodologies for purposes of describing the disclosed technology, but one of ordinary skill in the art may recognize that many further combinations and permutations of the disclosed technology are possible. Accordingly, the disclosed technology is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed technology. In this regard, it will also be recognized that the disclosed technology includes a system as well as a computer-readable medium having computer-executable instructions for performing the acts and/or events of the various methods of the disclosed technology.

In addition, while a particular feature of the disclosed technology may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system of controlling automated deployment of content and workloads within an industrial system, the system comprising:
a processor configured to:
receive deployment data to be deployed within the industrial system;
generate a data packet based on the deployment data; and
control deployment of the data packet to a set of industrial controllers included in the industrial system.

2. The system of claim 1, wherein the data packet is deployed to a first industrial controller using an application programming interface (API).

3. The system of claim 2, wherein the API is a representational state transfer (REST) API.

4. The system of claim 2, wherein the API is local to the first industrial controller.

5. The system of claim 1, wherein each industrial controller of the set of industrial controllers is a programmable logic controller (PLC).

6. The system of claim 1, wherein the deployment data includes at least one of: firmware, a security credential, a configuration file, a patch, a state, a binary, a user program, or a workflow.

7. The system of claim 1, wherein the deployment data relates to deployment of firmware and a user program, and wherein the data packet includes the firmware and the user program.

8. The system of claim 1, wherein a first industrial controller of the set of industrial controllers is configured to:
receive the data packet;
determine an authorization status of the deployment data based on deployment permission data; and
control installation of the data packet based on the authorization status.

9. The system of claim 8, wherein the first industrial controller is configured to determine the authorization status of the deployment data using at least one public key associated with a security authority that the first industrial controller trusts.

10. The system of claim 9, wherein the first industrial controller is configured to control installation of the data packet by preventing installation of the data packet when the authorization status of the deployment data indicates that deployment of the data packet to the first industrial controller is not authorized.

11. The system of claim 9, wherein the first industrial controller is configured to control installation of the data packet by installing the data packet at the first industrial controller when the authorization status of the deployment data indicates that deployment of the data packet to the first industrial controller is authorized.

12. A method of controlling automated deployment of content and workloads within an industrial system, the method comprising:
receiving, with an electronic processor, deployment data to be deployed within the industrial system;
generating, with the electronic processor, a data packet based on the deployment data; and
controlling, with the electronic processor, deployment of the data packet to a plurality of programmable logic controllers (PLCs) included in the industrial system.

13. The method of claim 12, wherein controlling, with the electronic processor, deployment of the data packet includes deploying the data packet to a first PLC of the plurality of PLCs using an application programming interface (API) of the first PLC.

14. The method of claim 12, further comprising:
controlling, with the electronic processor, deployment of a security policy to at least one PLC of the plurality of PLCs, wherein the security policy is stored locally to the at least one PLC, and wherein the at least one PLC is configured to determine an authorization status associated with the deployment data to be deployed within the industrial system using the security policy.

15. The method of claim 14, wherein controlling, with the electronic processor, deployment of the security policy includes deploying a deployment key to the at least one PLC, wherein the deployment key is to be utilized by the at least one PLC to authorize the deployment data prior to installation of the deployment data at the at least one PLC.

16. A non-transitory, computer-readable medium storing instructions that, when executed by one or more electronic processors, perform a set of functions, the set of functions comprising:
receiving deployment data to be deployed within an industrial system;
generating a data packet based on the deployment data; and
controlling deployment of the data packet to a plurality of programmable logic controllers (PLCs) included in the industrial system.

17. The computer-readable medium of claim 16, wherein controlling deployment of the data packet includes deploying the data packet to a first PLC of the plurality of PLCs using an application programming interface (API) of the first PLC.

18. The computer-readable medium of claim 16, wherein a first PLC of the plurality of PLCs is configured to:
responsive to receipt of the data packet:
determining an authorization status associated with the deployment data to be deployed within the industrial system; and
controlling local installation of the data packet based on the authorization status.

19. The computer-readable medium of claim 18, wherein determining the authorization status includes determining the authorization status based on a role of a user associated with the deployment data.

20. The computer-readable medium of claim 16, wherein receiving the deployment data includes receiving at least one of: firmware, a security credential, a configuration file, a patch, a state, a binary, a user program, or a workflow.
